(19) United States
(12) Patent Application Publication
(10) Pub. No.: US 2025/0322202 A1
(43) Pub. Date: Oct. 16, 2025

(54) DETERMINISTIC EXPLANATION OF SPARSELY CONNECTED MULTI-LAYER MACHINE LEARNING MODEL USING LATENT FEATURE ACTIVATION STATES

(71) Applicant: FAIR ISAAC CORPORATION, Minneapolis, MN (US)

(72) Inventors: Scott Michael Zoldi, San Diego, CA (US); Krzysztof Nalborski, San Diego, CA (US); Michael James Thompson, Madison, WI (US)

(21) Appl. No.: 18/634,652

(22) Filed: Apr. 12, 2024

(51) Int. Cl. G06N 3/04

(52) U.S. Cl. CPC G06N 3/04

(57) ABSTRACT

A method for generating explanations for a multi-layer model, comprising: accessing a multi-layer model, wherein the multi-layer model comprises an input layer, one or more hidden layers, and an output layer, wherein the input layer comprises a plurality of input features for the multi-layer model, each hidden layer of the one of more hidden layers comprises a plurality of latent features, wherein each latent feature is connected to the input layer or a preceding hidden layer by a limited number of input connections, and the output layer is capable of generating an output based at least in part on activation states of terminal latent features in a final hidden layer, wherein the terminal latent features are a subset of the latent features that are connected directly to the output layer; upon receiving an output generated by the multi-layer model, generating an output explanation.

### TECHNICAL FIELD

The subject matter described herein relates to systems and methods for using Machine Learning (ML) technique to deterministically explain interpretable neural network models, for generating deterministic explainable classifiers and/or models.

### BACKGROUND

In recent years, Machine Learning (ML) models have gained widespread adoption across various industries for predictive purposes. For instance, in the retail sector, predictive models are utilized to forecast customer demand, optimize inventory levels, and personalize marketing campaigns, ultimately resulting in increased sales and improved customer satisfaction. In healthcare, predictive models play a crucial role in patient diagnosis, treatment recommendations, and disease outbreak predictions, contributing to enhanced patient care and proactive healthcare management. Furthermore, within the financial industry, ML models are employed for credit risk assessment, fraud detection, and market trend predictions, thereby enhancing decision-making processes, and mitigating potential risks. These examples illustrate the substantial impact of predictive ML models, transforming industries and driving data-driven decision-making across diverse sectors.

There are cases where providing explanations for machine learning classifier outputs becomes essential or, in some instances, required, due to, for example, regulatory requirements. Moreover, these explanations can offer valuable insights for further model development in various scenarios. Some models are inherently explainable, for example, linear regression, logistic regression, and single decision trees. These linear and logistic models possess transparent additive structures that allow users to see the direct relationship between input features and outputs value. Linear and logistic regression models, for instance, provide coefficients for each feature, indicating the weight or importance of that feature in prediction represented by a weighted sum of contribution. Decision trees, on the other hand, offer a hierarchical structure of decisions based on feature values, making the path to any prediction traceable and understandable by following thresholds down a single decision tree path. Such models are traditionally used when interpretability is paramount, despite often sacrificing predictive accuracy compared to more complex counterparts such as interpretable neural networks. Interpreting the results of complex machine learning models, including deep neural networks, random forests, and support vector machines, is often impossible due to the very large number of activation paths for these models. The interplay and weighting of features are non-intuitive in these multi-layer structures, making it potentially not possible to pinpoint the exact contributions of individual features to the final decision. Moreover, the features are inputs to more complex nonlinear relationships (e.g., latent features in neural networks) that are responsible and may represent the physical or causal relationship/reason that should be explained. Random forests, which rely on aggregating decisions from a multitude of decision trees, introduce another layer of complexity when adding a large number of ‘partial contributions’ to what is an average explanation and could potentially be un-useful in a true explanation exercise or to fulfill regulatory scrutiny.

While models that are explainable typically are constrained to have a simpler and more tractable model structure, there is a growing demand to leverage more complex models, such as neural networks, while still maintaining the ability to provide clear explanations that link to actual observed occurrences in the data to provide factual explanations of what drove the output score and to allow those impacted an opportunity to make the right changes in behavior to improve those scores.

### SUMMARY

Methods, systems, and articles of manufacture, including computer program products, are provided for generating explanations for a multi-layer model. In one aspect, there is provided a method for generating explanations for a multi-layer model, the method comprises: accessing a multi-layer model, wherein the multi-layer model comprises an input layer, one or more hidden layers, and an output layer, wherein the input layer comprises a plurality of input features for the multi-layer model, each hidden layer of the one of more hidden layers comprises a plurality of latent features, wherein each latent feature is connected to the input layer or a preceding hidden layer by a limited number of input connections, wherein each latent feature is associated with an activation state matrix, wherein an explanation of a latent feature is selected based on an activation state of said latent feature, and the output layer is capable of generating an output based at least in part on activation states of terminal latent features in a final hidden layer, wherein the terminal latent features are a subset of the latent features that are connected directly to the output layer, and the final hidden layer comprises the terminal latent features; upon receiving an output generated by the multi-layer model, generating an output explanation by: removing the input features; removing the latent features that are in non-activation state; selecting an explanation of each of the remaining latent features based at least in part on a number of input connections after the removals; and combining the explanations associated with the remaining latent features to generate the output explanation.

In some variations, generating the output explanation further comprises: ranking pre-activation terms associated with the remaining terminal latent features, respectively; and generating the output explanation by combining the explanations associated with the remaining terminal latent features in an order of the ranking.

In some variations, the explanation of the latent feature is selected by: retrieving pre-activation terms for each input connections connected to the latent feature by multiplying a value of each input connection by a corresponding weight of the input connection; transforming the pre-activation terms by an activation function to determine an activation mode for each input connection, wherein the activation modes include negative activation, non-activation, and positive activation; identifying an activation state for the latent feature by combining the activation modes of the input connections of the latent feature, wherein the activation state corresponds to a cell in the activation state matrix; and selecting an explanation that corresponds to the identified activation state for the latent feature.

In some variations, selecting an explanation that corresponds to the identified activation state for the latent feature further comprises resolving bimodal states by comparing magnitudes of the transformed pre-activation terms of the input connections to determine which input connection has a stronger influence on the latent feature.

In some variations, generating the output explanation further comprises: ranking pre-activation terms associated with the terminal latent features, respectively; identifying the terminal latent features with the pre-activation term that exceeds a threshold, and generating the output explanation by combining the explanations associated with the identified terminal latent features in an order of the ranking.

In some variations, the limited number is restricted to either one or two input connections per latent feature.

In some variations, selecting an explanation of each of the remaining latent features based at least in part on a number of input connections after the removals further comprises: selecting an explanation for a remaining latent feature based on an activation state of said remaining latent feature if the number of input connections is zero after the removals; and selecting an explanation for remaining latent feature based on an activation state of an input connection if the number of input connections is one after the removals.

In another aspect, there is provided a computer program product including a non-transitory computer readable medium storing instructions that, when executed by at least one programmable processor, cause the at least one programmable processor to perform operations. The operations include accessing a multi-layer model, wherein the multi-layer model comprises an input layer, one or more hidden layers, and an output layer, wherein the input layer comprises a plurality of input features for the multi-layer model, each hidden layer of the one of more hidden layers comprises a plurality of latent features, wherein each latent feature is connected to the input layer or a preceding hidden layer by a limited number of input connections, wherein each latent feature is associated with an activation state matrix, wherein an explanation of a latent feature is selected based on an activation state of said latent feature, and the output layer is capable of generating an output based at least in part on activation states of terminal latent features in a final hidden layer, wherein the terminal latent features are a subset of the latent features that are connected directly to the output layer, and the final hidden layer comprises the terminal latent features; upon receiving an output generated by the multi-layer model, generating an output explanation by: removing the input features; removing the latent features that are in non-activation state; selecting an explanation of each of the remaining latent features based at least in part on a number of input connections after the removals; and combining the explanations associated with the remaining latent features to generate the output explanation.

In another aspect, there is provided a system comprising: a programmable processor; and a non-transient machine-readable medium storing instructions that, when executed by the processor, cause the at least one programmable processor to perform operations. The operations include accessing a multi-layer model, wherein the multi-layer model comprises an input layer, one or more hidden layers, and an output layer, wherein the input layer comprises a plurality of input features for the multi-layer model, each hidden layer of the one of more hidden layers comprises a plurality of latent features, wherein each latent feature is connected to the input layer or a preceding hidden layer by a limited number of input connections, wherein each latent feature is associated with an activation state matrix, wherein an explanation of a latent feature is selected based on an activation state of said latent feature, and the output layer is capable of generating an output based at least in part on activation states of terminal latent features in a final hidden layer, wherein the terminal latent features are a subset of the latent features that are connected directly to the output layer, and the final hidden layer comprises the terminal latent features; upon receiving an output generated by the multi-layer model, generating an output explanation by: removing the input features; removing the latent features that are in non-activation state; selecting an explanation of each of the remaining latent features based at least in part on a number of input connections after the removals; and combining the explanations associated with the remaining latent features to generate the output explanation.

Methods, systems, and articles of manufacture, including computer program products, are provided for generating a multi-layer model. In one aspect, there is provided a method comprises: maintaining an input layer comprising a plurality of input features for the multi-layer model; training the multi-layer model to generate one or more hidden layers, wherein each hidden layer comprises a plurality of latent features, wherein each latent feature is connected to the input layer or a preceding hidden layer by a limited number of input connections, wherein each latent feature is associated with an activation state matrix, and wherein an explanation of a latent feature is selected based on an activation state of said latent feature; and maintaining an output layer of the multi-layer model that is configured to generate an output based at least in part on activation states of terminal latent features in a final hidden layer, wherein the terminal latent features are a subset of the latent features that are connected directly to the output layer, and the final hidden layer comprises the terminal latent features.

In some variations, the output is associated with an output explanation, wherein the output explanation is generated by: ranking pre-activation terms associated with the terminal latent features, respectively; identifying the terminal latent features with the pre-activation term that exceeds a threshold, and generating the output explanation by combining the explanations associated with the identified terminal latent features in an order of the ranking.

In some variations, the output is associated with an output explanation, wherein the output explanation is generated by: removing the input features; removing the latent features that are in non-activation state; selecting an explanation of the remaining terminal latent features based at least in part on a number of input connections after the removals; ranking pre-activation terms associated with the remaining terminal latent features, respectively; generating the output explanation by combining the explanations associated with the remaining terminal latent features in an order of the ranking.

In some variations, the limited number is restricted to either one or two input connections per latent feature.

In some variations, each connection between the input features and the latent features, between latent features across successive hidden layers, and between the latent features in the final hidden layer and the output layer, is associated with a weight.

In some variations, the explanation of the latent feature is selected by: retrieving pre-activation values for each input connections connected to the latent feature by multiplying a value of each input connection by a corresponding weight of the input connection; transforming the pre-activation values by an activation function to determine an activation mode for each input connection, wherein the activation modes include negative activation, non-activation, and positive activation; identifying an activation state for the latent feature by combining the activation modes of the input connections of the latent feature, wherein the activation state corresponds to a cell in the activation state matrix; and selecting an explanation that corresponds to the identified activation state for the latent feature.

In some variations, selecting an explanation that corresponds to the identified activation state further comprises resolving bimodal states by comparing magnitudes of the transformed pre-activation values of the input connections to determine which input connection has a stronger influence on the latent feature.

In an aspect, there is provided a computer program product including a non-transitory computer readable medium storing instructions that, when executed by at least one programmable processor, cause the at least one programmable processor to perform operations. The operations include maintaining an input layer comprising a plurality of input features for the multi-layer model; training the multi-layer model to generate one or more hidden layers, wherein each hidden layer comprises a plurality of latent features, wherein each latent feature is connected to the input layer or a preceding hidden layer by a limited number of input connections, wherein each latent feature is associated with an activation state matrix, and wherein an explanation of a latent feature is selected based on an activation state of said latent feature; and maintaining an output layer of the multi-layer model that is configured to generate an output based at least in part on activation states of terminal latent features in a final hidden layer, wherein the terminal latent features are a subset of the latent features that are connected directly to the output layer, and the final hidden layer comprises the terminal latent features.

In an aspect, there is provided a system comprising: a programmable processor; and a non-transient machine-readable medium storing instructions that, when executed by the processor, cause the at least one programmable processor to perform operations. The operations include maintaining an input layer comprising a plurality of input features for the multi-layer model; training the multi-layer model to generate one or more hidden layers, wherein each hidden layer comprises a plurality of latent features, wherein each latent feature is connected to the input layer or a preceding hidden layer by a limited number of input connections, wherein each latent feature is associated with an activation state matrix, and wherein an explanation of a latent feature is selected based on an activation state of said latent feature; and maintaining an output layer of the multi-layer model that is configured to generate an output based at least in part on activation states of terminal latent features in a final hidden layer, wherein the terminal latent features are a subset of the latent features that are connected directly to the output layer, and the final hidden layer comprises the terminal latent features.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an example of a fully-connected neural network model with a hidden layer, in accordance with one or more embodiments of the current subject matter.

FIG. 2 is a diagram illustrating an example of a single latent feature LF1 with two incoming connections, in accordance with one or more embodiments of the current subject matter.

FIG. 3 is a diagram illustrating an example of a bounded activation function, in accordance with one or more embodiments of the current subject matter.

FIG. 4 is a diagram illustrating an example of an activation state matrix for a latent feature, in accordance with one or more embodiments of the current subject matter.

FIG. 5 is a diagram illustrating an example of latent features with two incoming connections and their hyperbolic tangent-transformed pre-activation terms, in accordance with one or more embodiments of the current subject matter.

FIG. 6 is a diagram illustrating two examples of a bimodal latent feature LF1 with two incoming connections and their hyperbolic tangent-transformed pre-activation terms, in accordance with one or more embodiments of the current subject matter.

FIG. 7 is an example of a table that represents an activation-state matrix for a latent feature, in accordance with one or more embodiments of the current subject matter.

FIG. 8 is a diagram illustrating an example of generating explanation(s) for an output from a neural network with a single hidden layer, in accordance with one or more embodiments of the current subject matter.

FIG. 9 is a diagram illustrating an example of generating explanation(s) for an output from a neural network with multiple hidden layers, in accordance with one or more embodiments of the current subject matter.

FIG. 10 depicts a block diagram illustrating a computing system consistent with implementations of the current subject matter.

FIG. 11 is a diagram illustrating a flow chat of a process for generating an output explanation for the model, in accordance with one or more embodiments of the current subject matter.

FIG. 12 is a diagram illustrating a flow chat of a process for generating an output explanation for the model, in accordance with one or more embodiments of the current subject matter.

When practical, like labels are used to refer to same or similar items in the drawings.

### DETAILED DESCRIPTION

The details of one or more variations of the subject matter described herein are set forth in the accompanying drawings.

As discussed herein elsewhere, neural network models have been commonly used in numerous applications across different industries to solve many challenging problems. Whether it has been for credit and debit card fraud detection or loan default prediction in banking, medical image classification in healthcare and speech recognition in natural language processing, neural networks have proven to be a powerful form of machine learning enabling decision makers to gain competitive advantage and consequently grow their market share. As neural networks and other machine learning models have become mainstream and their adoption has grown, it attracted interest from regulators and governing bodies to take a closer look at how these algorithms are used to make different decisions. In some situations, automated decisions made with the help of machine learning models such as neural networks affect lives of many people, and there exist needs to ensure the models be developed and deployed in a way that emphasizes fairness, transparency, and accountability.

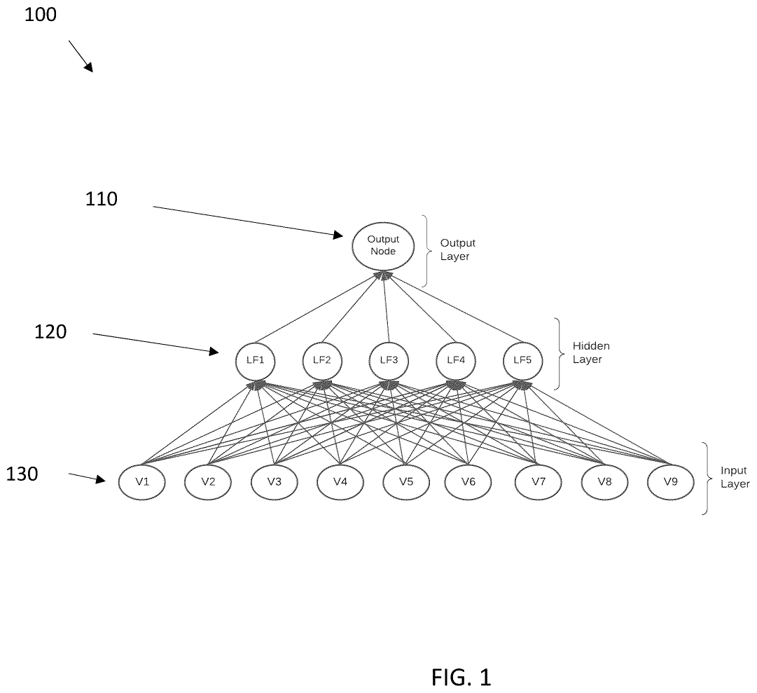

FIG. 1 is a diagram illustrating an example of a neural network model 100 with a hidden layer 120, in accordance with one or more embodiments of the current subject matter. As shown in FIG. 1, the neural network model 100 includes an input layer 130, one hidden layer 120, and one output layer 110. In some embodiments, the neural network model 100 may include multiple hidden layers 120. The input layers 130 may include input features, for example, features (V1, . . . , V9) as shown in FIG. 1. The input layers 130 may pass the input features to the following hidden layer(s) 120. Latent features (LF1, . . . , LF5) represent typically multitudes of complex relationships learned by the network during training (for example, non-linear transformations, and/or interactions of input features). These multitude of relationships are known as multi-modal activations of the latent features. The hidden layer(s) 120 is the predictive component of a neural network as it enables modeling of non-linear behaviors. The output layer 110 combines all the latent features connecting to it, thereby producing an output score to be used for decisioning. As shown in FIG. 1, the complexity of a neural network makes even a simple network with a single hidden layer and dense connections (i.e., fully connected) very hard to understand and explain. In this example in FIG. 1, each latent feature combines information from 9 input variables, which makes these densely connected latent features inherently unexplainable assuming there are 3 possible activation modes (Positive-activation, non-activation, and Negative-activation) for each input feature into the latent feature. Each single latent feature of the five in FIG. 1 therefore supports 19,683 possible activation states (i.e., 3⁹) and within each state there can be even more possible explanation activation modes. The combinatorial explosion of possible reasons for a latent feature activation in dense networks makes explaining the neural network 100 intractable to codify and even if one was able to assign reasons (some indeed multiple reasons for each activation state) to each of the 19,683 activation states for each latent feature—such an explosion of explanations would be in-tractable to any human and regulation, thus impairing the path to deployments of fully connected neural networks in highly regulated industries and environments.

As described in connection with FIG. 1, while the mathematical calculations and equations used within neural networks are often straightforward, creating human palatable explanation can be a very challenging task as the underlying latent features are multi-modal making impossible the identification of deterministic behavior of what saturates and drives the latent features and consequently the outcomes, Therefore, neural networks are often called “black box” models because their traditional architectures remain unexplainable and consequently incompatible with heavily regulated industries. Therefore, there is a need for platforms, systems, and methods that generate interpretable neural networks and provide demonstrated deterministic explanations for their outputs.

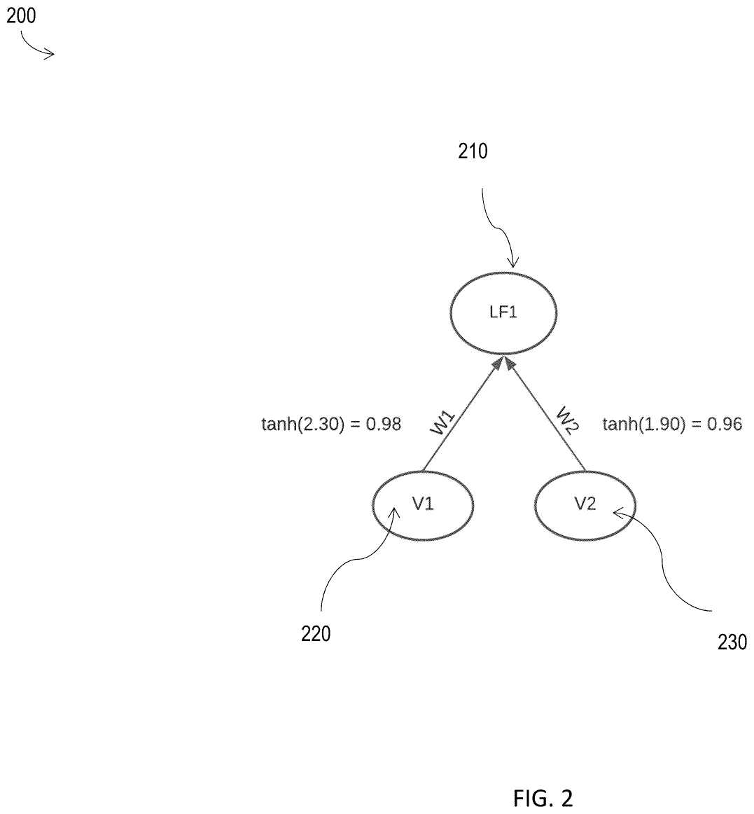

FIG. 2 is a diagram illustrating an example of a single latent feature LF1 with two incoming connections, in accordance with one or more embodiments of the current subject matter. As shown in FIG. 2, the limited number of inputs (i.e., input connections or incoming connections) allowed into a single hidden latent feature 210 is limited to no more than two connections. While three or more inputs are possible, the network explainability decreases, and multi-modal behaviors of the individual state assignments become too difficult to resolve.

In some embodiments, a highlander-based constrained neural network constrained to allow only one or two input connections for every latent feature may be constructed. For example, in some embodiments, to train neural network models with highlander constraints, the process may involve defining a neural network architecture with limited input connections per latent feature, initializing weights and biases, and preparing the training data. In some embodiments, a specialized training algorithm may be utilized to enforce the highlander constraints, typically through penalization, selective weight updates, or connection pruning. In some embodiments, activation functions and thresholds are chosen to facilitate interpretable activation modes. In some embodiments, during training, data is fed into the input layer, and signals propagate through the hidden layers to the output layer. The weights determine the strength of the signal that passes from one node to another. During training, one or more loss functions may be utilized to fit the model (train the weights of latent features) more closely align the outputs of the neutral network with the true outcomes in the training dataset. The weights are adjusted to minimize the error in the output prediction compared to true outcome data in the training data, and loss functions are calculated through an optimization algorithm to adjust weights to better align output prediction with the true outcomes in the training data. In some embodiments, the optimization process ensures that highlander constraints are enforced by limiting the number of input features connected to each latent feature. In some embodiments, after training, the model's adherence to the highlander constraints is verified before deployment. The model structure and the weights associated with each connection may be packaged in a configuration package, which may be stored in a configuration repository of the platform.

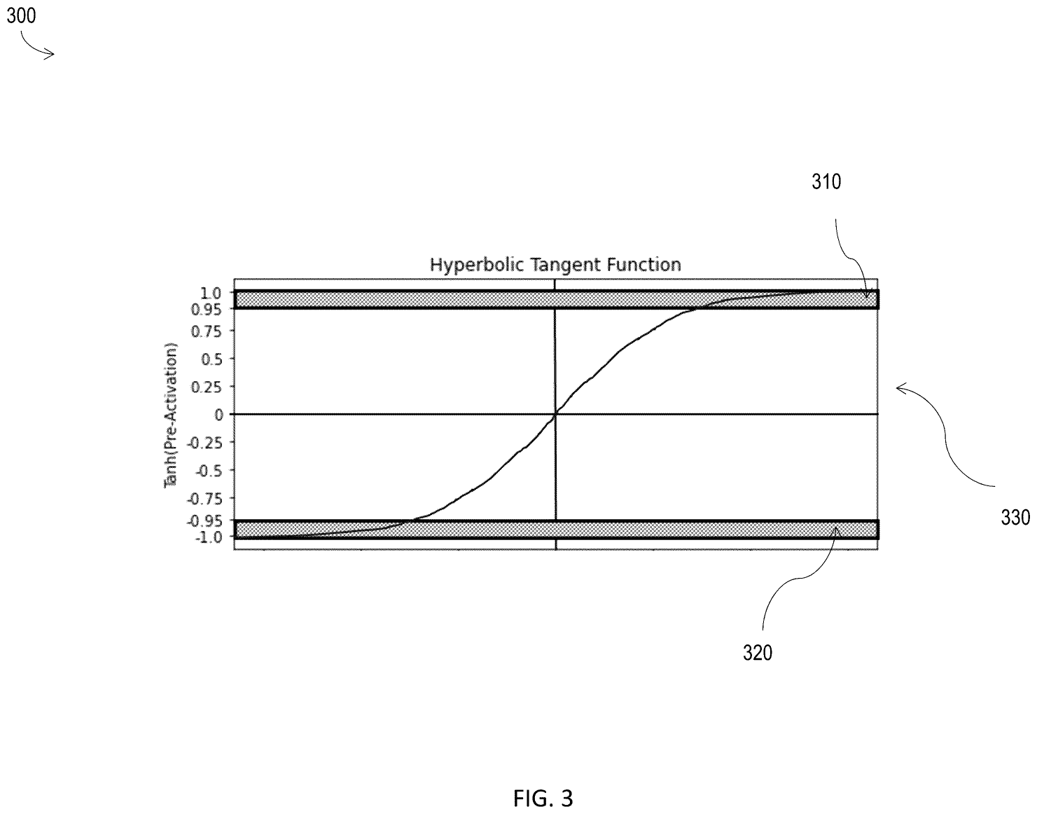

Each latent feature, as shown in FIG. 3, may further have a sigmoidal-type activation function (e.g., hyperbolic tangent (tanh) function), where per the subject matter described herein, there are three possible activation modes. In some embodiments, the three activations modes for a single latent feature may include Positive activation mode denoted by 1, Off mode denoted by 0, and Negative activation mode denoted by −1.

The assignment of activation states for each latent feature may be based on the three activation modes, assuming a bounded activation function such as tanh, can be determined by assigning activation value thresholds based on 3 tanh-specific regions (see FIG. 3). The thresholds related to asymptotic regions of the latent feature are of the primary interest because they identify the value at which an input feature would be strong enough itself to activate the latent feature in absence of a contribution of the second input feature, therefore making that input feature “remarkable” from an explanation standpoint.

As shown in FIG. 2, individual input feature activations may be based on the value of the normalized pre-activation term that said input feature (e.g., V1 220, and/or V2 230) contributes to the latent feature LF1 210. The pre-activation term is the input feature value for a particular data point multiplied by the network weight (e.g., W1, and/or W2) associating that input feature to the latent feature (e.g., V1*W1=2.30 in FIG. 2).

FIG. 3 is a diagram illustrating an example of a bounded activation function, in accordance with one or more embodiments of the current subject matter. As shown in FIG. 3, the bounded activation function may include hyperbolic tangent (tanh) function. The asymptotic regions are represented by the small checkerboard pattern areas 310 and 320 (i.e., darker area 310 and 320). As shown in FIG. 3, the darker areas 310 and 320 correspond to Positive (1) and Negative (−1) activation modes for a single hidden latent feature limited to 1 input connection. The white solid fill area 320 between 0.95 and −0.95 represents the Off (0) mode.

The bounded activation function 300 may also be used to normalize individual pre-activation terms. In some embodiments, the bounded activation function 300 is tanh function. In some embodiments, if the tanh (pre-activation value) exceeds a pre-determined threshold, then the input feature is “remarkable” and itself capable of firing the latent feature with zero contribution from the second input. The three threshold definitions used to define the three activation modes may include:
Negative activation (−1) mode is assigned for tanh (pre-activation) values <=−0.95,
Off (0) mode is assigned for tanh (pre-activation) values >−0.95 and <0.95,
Positive activation (1) mode is assigned for tanh (pre-activation) values >=0.95.

In this case, the pre-determined threshold is set to be −0.95 and 0.95; other thresholds may be selected based on the specific activation function characteristics and the desired sensitivity for feature activation. In some embodiments, the thresholds can be defined differently by a platform user and may represent values that are close to the saturated regions of the activation function. Saturated regions of the activation function may refer to the areas near the function's asymptotes where the output of the function changes minimally in response to increasing or decreasing values of the input values, typically corresponding to the extreme values of the function's range. A saturated hidden node may be defined as a node that has a value close to the upper or the lower bound of an activation function where the node is considered saturated.

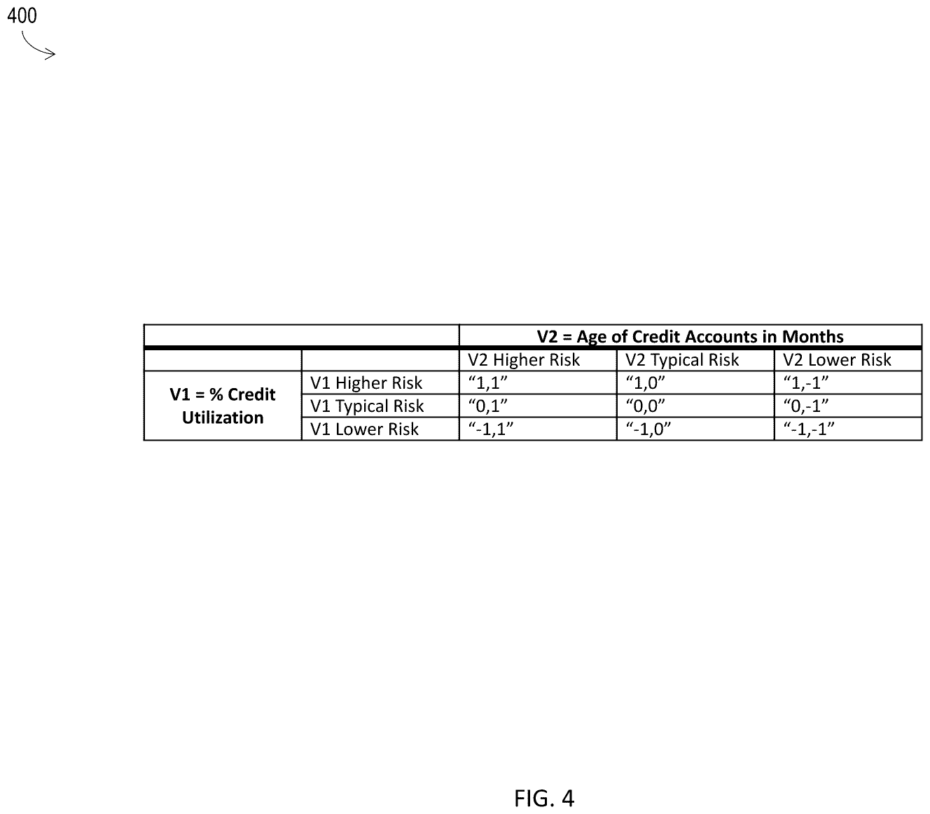

FIG. 4 is a diagram illustrating an example of an activation state matrix for a latent feature LF1, in accordance with one or more embodiments of the current subject matter. As shown in FIG. 4, there are nine possible latent feature activation states (3², from three activation modes per hidden latent feature and two input connections). The process of associating activation modes based on individual tanh-transformed pre-activation terms of the inputs, to 1 of the 9 activation states is based on the corresponding activation modes of the input connections. For example, if the input connection V1 provides a Positive mode 1, and the input connection V2 provide a Negative mode 0, then the activation state of the latent feature would be (1, 0), which corresponds to one of the nine cells in FIG. 4.

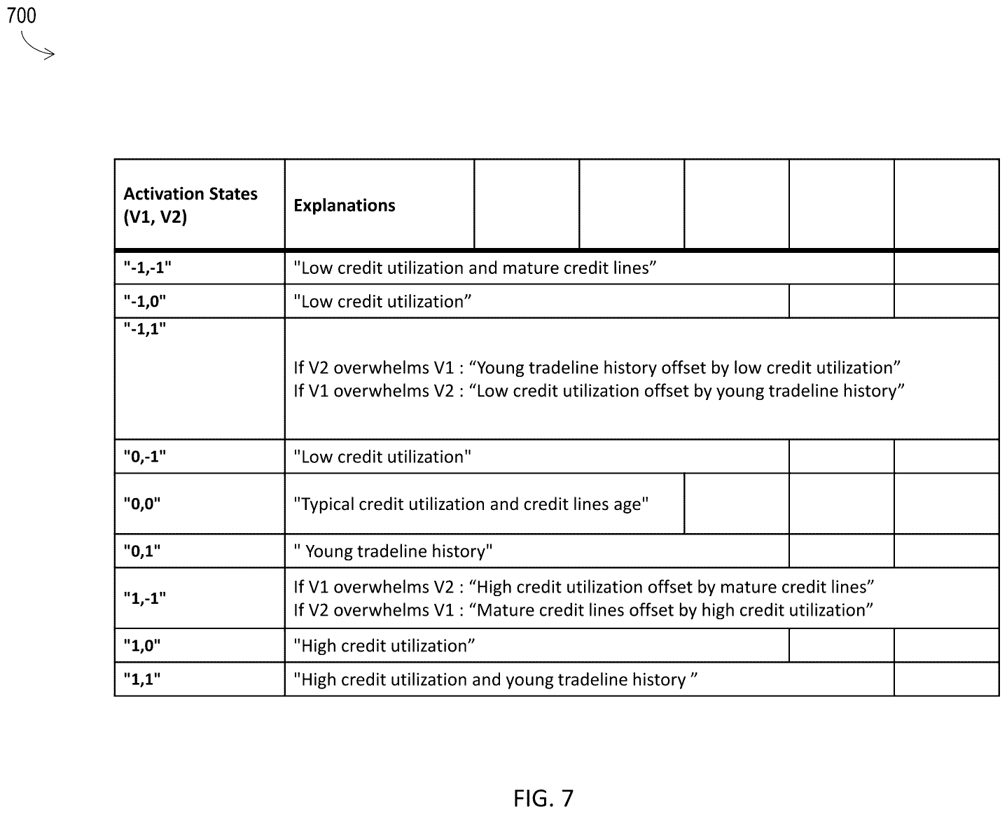

As shown in connection with FIG. 2, a latent feature 210 with two input connections 220 and 230 may be associated with nine possible activation states, corresponding to the nine cells in the table 400 in FIG. 4. Per the subject matter described herein, as shown in FIG. 7, an activation state matrix with explanations may be generated for each latent feature representing the nine possible activation states, and it should be noted that there are two activation states of the nine that are multi-modal, i.e., (1, −1) and (−1, 1). This results in eleven explanations for the nine possible activation states of a given latent feature with two incoming connections.

The activation states may be used to explain, in a deterministic human understandable way, the model explanation modes that are associated with the latent feature activation states and associated explanations. Written explanations for each activation state of each latent feature may be provided in the form of a configuration matrix as shown in FIG. 7. In some embodiments, a platform user may review the all the explanation associated with the activation states to enable comprehension for a human.

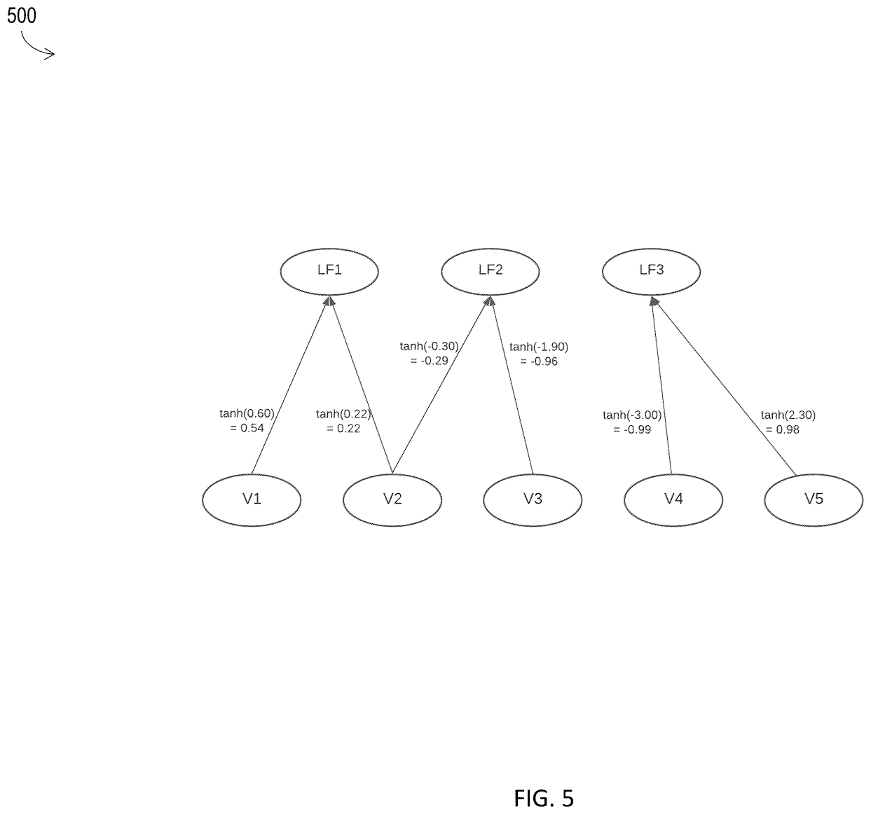

FIG. 5 is a diagram illustrating an example of latent features with two incoming connections and their bounded pre-activation terms (e.g., hyperbolic tangent-transformed pre-activation terms), in accordance with one or more embodiments of the current subject matter. As shown in FIG. 5, there are three latent features, each with two input connections drawn from five unique input features. The activation modes and the activation states of each latent feature are:
(0, 0) for LF1 because both tanh-transformed pre-activation input features are in the Off state, as each input not exceeding the firing threshold. This leads to an explanation, for example, corresponding to the (0, 0) in FIG. 7.
(0, −1) for LF2 because V2's state is set to Off and only the tanh-transformed pre-activation input feature of V3 exceeds the negative activation firing threshold. This leads to an explanation, which would be defined analogously to (0, −1) in FIG. 7 but for V2 and V3.
(−1, 1) for LF3 because both tanh-transformed pre-activation input features exceed the negative and positive, respectively, activation firing threshold. This leads to an explanation, which would be defined analogously to the (−1, 1) in FIG. 7 but defined for V4 and V5.

Therefore, the activation state for a latent feature is based on the activation mode of the input connections linked to the latent feature. In some embodiments, since there are two input connections to a latent feature, the activation state for the latent feature is in a format of (x, y), wherein x and y are 1, 0, or −1. The activation mode of each of the input connections are combined to form the activation state for the latent feature. In some embodiments, a latent feature may constitute an input connection to another latent feature when there are multiple hidden layers. In that case, the input latent feature to the second latent feature may have an activation mode that is determined based on the activation states of the preceding latent feature. For example, if the activation states are (−1, −1), (−1, 0), (0, −1), then the activation mode of the latent feature may be considered Negative, denoted by −1. If the activation states are (1, 1), (1, 0), (0, 1), then the activation mode of the latent feature may be considered Positive, denoted by 1. For other activation states, such as mixed states the positive, negative, or zero will be based on relative size of the inputs −1, and 1 of the preceding latent feature.

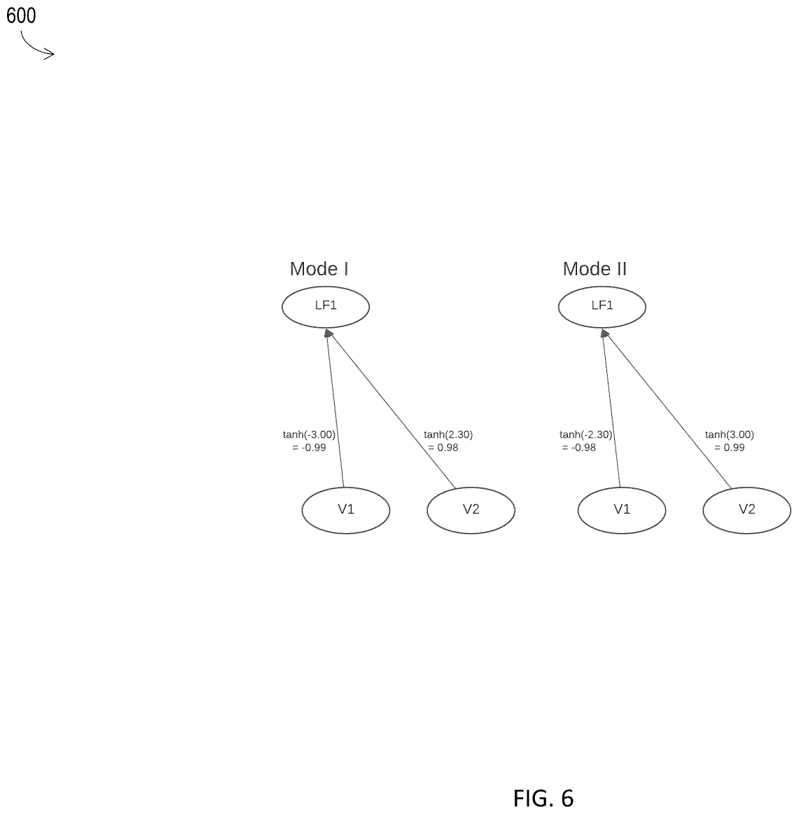

FIG. 6 is a diagram illustrating examples of a bimodal latent feature LF1 with two incoming connections and their hyperbolic tangent-transformed pre-activation terms, in accordance with one or more embodiments of the current subject matter. As shown in FIG. 6, a bimodality type of activation state of (−1, 1) and/or (1, −1) may exist for a latent feature based on the activation modes of the input connections. In an example, input feature V1 represents % credit unitization, and input feature V2 represents the age of the credit account in months. As shown in FIG. 6, the bimodality of Mode I and Mode II of a mixed (−1, 1) state of a hidden latent feature LF1 with two incoming connections may exist. This activation state has two modes, and consequently two explanations, because either of the two input connections is strong enough itself to activate the LF1 in absence of a contribution of the second one and with either negative or positive activation depending on the relative size of the input connections. This bimodality needs to be resolved when constructing an explanation depending on which of the two inputs overwhelms the other one to drive the LF1 to saturation. To make this determination, the tanh-transformed pre-activation terms is sorted by the magnitude of their absolute values in a descending order.
Mode I: V1 overwhelms V2, and the explanation (for example, selected from the explanation matrix in FIG. 7) is “Low credit utilization offset by young tradeline history”
Mode II: V2 overwhelms V1, and the explanation (for example, selected from the explanation matrix in FIG. 7) is “Young tradeline history offset by low credit utilization”

In the 9-cell matrix of activation states (i.e., FIG. 7), there are two “mixed states” where the input feature modes contributing to the latent feature have opposite sign, e.g., (1, −1) or (−1, 1). In the cases of these mixed states, the latent feature can have one of two explanations depending on which of the two inputs is more “remarkable”, as evaluated by the magnitude of the tanh-transformed pre-activation terms' values. In other words, each of these mixed states exhibit “bimodality”. This bimodality results in eleven possible activation modes with eleven explanations for the nine possible states in the matrix, as seen in the state matrix in FIG. 7. Activation states are identified by the individual activations of inputs to the latent feature, and allows an identification of the activation state of the latent feature, explanations are then guided from the activation state per the methodology above.

FIG. 7 is an example of a table that represents an activation-mode based explanation matrix for a latent feature, in accordance with one or more embodiments of the current subject matter. As shown in FIG. 7, there may include nine states, and eleven possible explanations for a latent feature with two input connections. For each latent feature in the hidden layers, a table illustrating an activation state matrix for a latent feature with nine cells is created, the table may take form as the one in FIG. 4, and a table with explanation narratives referenced by activation state of the latent feature and input activations may be created, and this table may take form of the one in FIG. 7. In some embodiments, the activation state matrix with explanations associated with the latent feature's states may be packaged into a configuration package for the model. In some embodiments, the configuration package may be stored in the configuration repository of the platform, along with the trained model.

To select the explanation(s) for the output, the approach first identifies strongest drivers of the output by ranking the output pre-activation values. In some embodiments, the most “remarkable” drivers of the output are determined by traversing the model graph to identify the simplest explanations. In some embodiments, the output is a score that is calculated per a set of functions. In some embodiments, the output is a set of continuous scores.

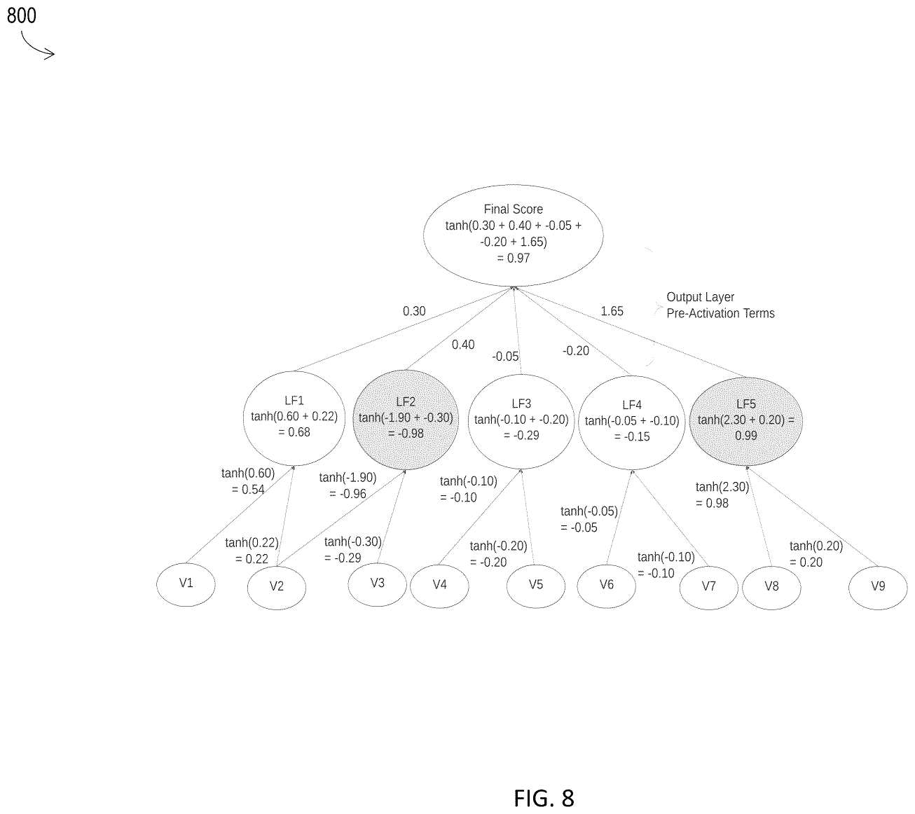

FIG. 8 is a diagram illustrating an example of generating explanation(s) for an output from a neural network with a single hidden layer, in accordance with one or more embodiments of the current subject matter. As shown in the FIG. 8, each of the five latent feature-level activation states are provided based on nine possible activation states for every latent feature with two inputs. In some embodiments, neural network model may have an arbitrary number of hidden nodes (i.e., latent features). In some cases, neural networks with 5-20 hidden nodes per hidden layer may be common. By constructing a neural network model with the highlander constraints as discussed herein, the number of input connections linked to a latent feature is either one or two. A 9-cell latent feature activation state matrix and the corresponding eleven explanations (analogous to FIG. 4 and FIG. 7) may be produced for each latent feature in the network. Consequently, this approach then provide an explanation to the output, based on which of the latent features are the strongest and most “remarkable” drivers of the output.

As shown in FIG. 8, there is only one single hidden layer for this model. There are nine input features and five latent features in this model graph 800. For each latent feature, only two input connections are allowed. The output layer pre-activation terms, as the main contributors to the final score at the output layer, are used to determine the hidden latent features that were the strongest drivers of the output score. In some embodiments, these pre-activation terms are sorted by the magnitude of their absolute values. This logic provides the following order of latent features [LF5, LF2, LF1, LF4, LF3]. Among the sorted output layer pre-activation terms, explanations only for the top 3 contributors (or top-n, as a configurable parameter) are presented to a user or a regulator. In some embodiments, if a selected latent feature fired in the (0, 0) state, it may be eliminated from providing the explanation, as it does not contribute to the output. Alternatively or additionally, the strongest drivers for the output are determined based on the number of terminal latent features that is required to best approximate the score based on output pre-activation. In an alternative embodiment, the strongest drivers of the output may be determined based on the number of terminal latent features required to best exceed the score based on output pre-activation.

As shown in FIG. 8, based on the output pre-activation values, LF5 and LF2 with (1, 0) and (−1, 0) activation states, respectively, are the strongest drivers of the final output score. Therefore, explanations to these latent features LF5 and LF2 would be provided based on the matrices of activations and explanations. LF1, although it is the 3^{rd} largest output layer contributor, is not included among the explanations because it fires in the (0, 0) state and does not contribute additional meaningful information.

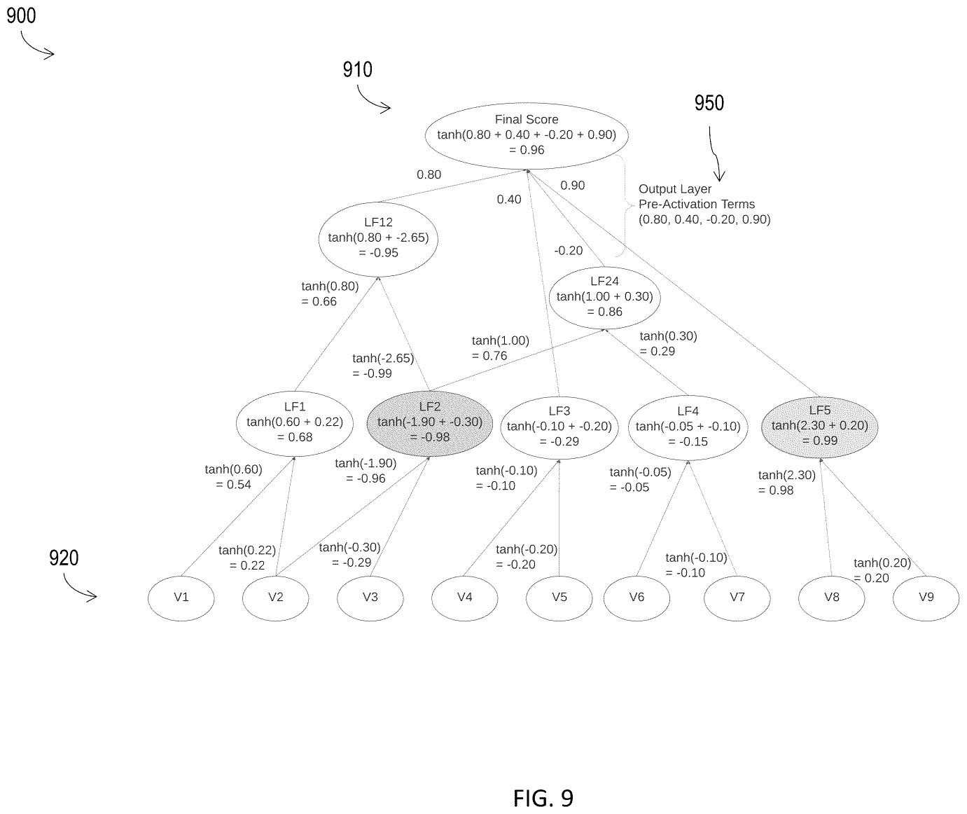

FIG. 9 is a diagram illustrating an example of generating explanation(s) for an output from a neural network with multiple hidden layers, in accordance with one or more embodiments of the current subject matter. As shown in FIG. 9, a neural network with multiple hidden layers may be provided to customers and/or users to make informed prediction and decisions. This neural network model is constructed in accordance with the embodiments described herein, i.e., each latent feature has only two input connections. As shown in FIG. 9, the output layer 910 may be connected with the final hidden layer which consists of the terminal latent features. In some embodiments, the final hidden layer is the last layer preceding the output layer. In some embodiments, the terminal latent features are the latent features that are directed connected with the output layer 910. For example, as shown in FIG. 9, the latent features LF12, LF3, LF24, and LF5 are the terminal latent features as they are directly connected with the output layer 910, and they collectively form the final hidden layer in this model graph 900.

In some embodiments, when generating explanations for an output, the strongest drivers of the output are determined as if it were a single-hidden-layer network. In other words, the terminal latent features may be selected based at least in part on the absolute values of the output layer pre-activation terms. In some embodiments, the number of latent features that are required to explain an output or an output score is determined based on the strongest influence on the output layer's pre-activation values. For example, the pre-activation values of the terminal latent features can be sorted by the magnitude of their absolute values, and the top-n terminal latent features with the greatest influence are selected for explanation. This configurable number, n, allows for flexibility in the level of detail provided in the explanation. In some embodiments, the determination of the number of latent features to explain the output score is based on a “best approximation” approach. The latent features that, when combined, provide the closest approximation to the actual output score are identified. This approach may involve a more complex analysis of the contributions of each latent feature to the output score, considering the magnitude of the pre-activation values, and the structure and weights of the network paths leading to the output. The goal is to capture the essence of the network's decision-making process in a simplified form. Once the number of latent features that are required to explain an output is determined, the approach may perform a number of operations. In some embodiments, the approach may start with removing the input features from the model graph 900. Referring to FIG. 9, all the input features (V1, . . . V9) 910 may all be removed from the graph 900, i.e., the explanation generation process will not consider those input features. Explanations may be based only on latent features but not the input features 910. This is because, a latent feature activation state is what drives the output and can be best described by the 9-cell matrix latent feature activation state matrix and will in its construction capture the correct explanation.

Next, the approach may remove all the latent features (i.e., hidden nodes) in the non-activation (0) states. This is because those latent features are considered “unremarkable” for explaining the score. As shown in FIG. 9, the latent features of LF1, LF3, LF24 and LF4 may be removed from consideration because they are in Off (0) state.

In some embodiments, the approach may then select an explanation of the remaining latent features based on the strength of the remaining latent features, the approach may traverse the graph backward toward the input. If an earlier latent feature has a large activation driving a later latent feature, then this earlier latent feature would have been sufficient on its own to activate the terminal latent feature. In that case, the explanation of the earlier latent feature is “remarkable” and takes priority over the later latent feature that it drives. If there is more than one path from a latent feature backward toward the inputs, that means that the combination of earlier latent features is required to explain the behavior of the network. In that case, the explanation of the later latent feature is “remarkable”. As shown in FIG. 9, when removing all the input features and the latent features in Off state, the remaining terminal latent features are LF12 and LF5. For LF12, if traversing the graph, there is one pathway backward toward the input because the LF1 first-order latent feature was pruned away, leaving only LF2. Therefore, the LF2 explanation will be used for the LF12 terminal node explanation. For LF5, since it is a first-order latent feature with a “remarkable” explanation, so the associated explanation will be used for the LF5 terminal node explanation.

In some embodiments, the approach may rank the explanations associated with terminal latent features according to the absolute value of the magnitude of the terminal node pre-activations. These pre-activation terms are represented by the output layer pre-activation terms 950. For example, as shown in FIG. 9, the LF5 pre-activation (0.9) exceeds the LF12 pre-activation (0.8). Therefore, the explanations are presented in the order of the explanation of LF5 followed by the explanation of LF2, which is a “remarkable” replacement for LF12.

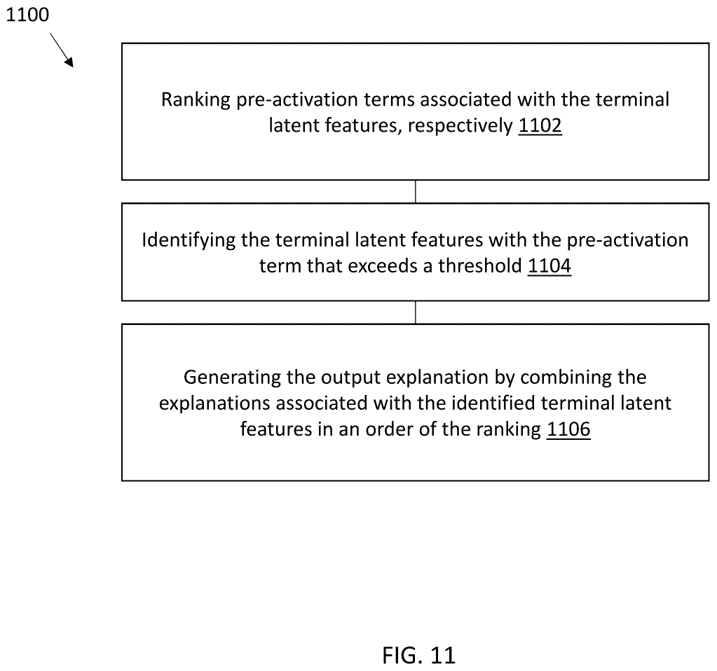

FIG. 11 is a diagram illustrating a flow chat of a process 1100 for generating an output explanation for the model, in accordance with one or more embodiments of the current subject matter. As shown in FIG. 11, the process 1100 may begin with operation 1102, wherein the system may rank the pre-activation terms associated with the terminal latent features, respectively. In some embodiments, the terminal latent features are the latent features that are connected directly to the output layer. Next, in operation 1104, the system may identify the terminal latent features with the hyperbolic tangent-transformed (or analogous) pre-activation term that exceeds a threshold. In some embodiments, the pre-activation values of the terminal latent features can be sorted by the magnitude of their absolute values, and the top-n terminal latent features with the greatest influence are selected for explanation. This configurable number, n, allows for flexibility in the level of detail provided in the explanation. In some embodiments, the determination of the number of latent features to explain the output score is based on a “best approximation” approach. The latent features that, when combined, provide the closest approximation to the actual output score are identified. This approach may involve a more complex analysis of the contributions of each latent feature to the output score, considering the magnitude of the pre-activation values, and the structure and weights of the network paths leading to the output. Next, the process 1100 may advance operation 1106, wherein the system may generate the output explanation by combining the explanations associated with the identified terminal latent features in an order of the ranking.

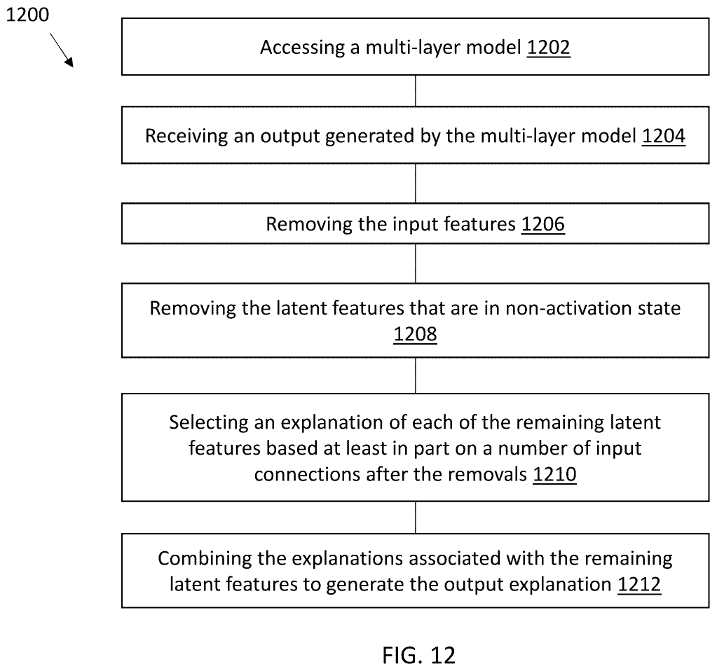

FIG. 12 is a diagram illustrating a flow chat of a process 1200 for generating an output explanation for the model, in accordance with one or more embodiments of the current subject matter. As shown in FIG. 12, the process 1200 may begin with operation 1202, wherein the system may access a multi-layer model. In some embodiments, the multi-layer model comprises an input layer, one or more hidden layers, and an output layer. In some embodiments, the input layer comprises a plurality of input features for the multi-layer model. In some embodiments, each hidden layer of the one of more hidden layers comprises a plurality of latent features, wherein each latent feature is connected to the input layer or a preceding hidden layer by a limited number of input connections. For example, the limited number of input connections may be not greater than two. In some embodiments, each latent feature is associated with an activation state matrix (e.g., the activation state matrix in FIG. 4), wherein an explanation of a latent feature is selected based on an activation state of said latent feature (e.g., by utilizing an explanation table as shown in FIG. 7). In some embodiments, the output layer is capable of generating an output based at least in part on activation states of terminal latent features in a final hidden layer. In some embodiments, the terminal latent features (i.e., the terminal nodes in the model group) are a subset of the latent features that are connected directly to the output layer. In some embodiments, the final hidden layer consists of the terminal latent features, i.e., all the terminal nodes collectively formed the final hidden layer. In operation 1204, the system may generate or receive an output generated by the multi-layer model. In some embodiments, upon receiving the output generated by the model, the system may remove all the input features from the model graph in operation 1206. One consideration is that explanations may be based only on latent features but not the input features 910. For example, a latent feature activation state is what drives the output and can be best described by the 9-cell matrix latent feature activation state matrix and would capture the more comprehensive explanation. Next, in operation 1208, the system may remove all the latent features that are in non-activation mode. This is because those latent features are considered “unremarkable” for explaining the score. Referring back to FIG. 9, the latent features of LF1, LF3, LF24 and LF4 may be removed from consideration because they are in non-activation state. In some embodiments, in operation 1210, the system may select an explanation of each of the remaining latent features based at least in part on a number of input connections after the removals. In some embodiments, after the removals of all the input features and the latent features that are in non-activation states, if a terminal latent feature is connected with zero input connection, then the explanation is selected based on the activation state (x, x) of the terminal latent feature itself (e.g., LF5 in FIG. 9). If, however, after removal, this terminal latent feature is still connected with one input connection, then it indicates that this particular input connection controls this terminal latent feature's read, therefore its explanation will be moved up to be the terminal latent feature's explanation. (e.g., LF24 still connects with LF2 after all the removals, therefore LF2's explanation is moved up to be LF24's explanation). In some embodiments, in operation 1212, the system may combine the explanations associated with the remaining latent features to generate the output explanation. In some embodiments, the system may rank pre-activation terms associated with the remaining terminal latent features, and generate the output explanation by combining the explanations associated with the remaining terminal latent features in an order of the ranking. For example, referring back to FIG. 9, when removing all the input features and the latent features in non-activation state, the remaining latent features are LF12 and LF5. For LF12, if traversing the graph, there is one pathway backward toward the input because the LF1 first-order latent feature was pruned away, leaving only LF2. Therefore, the LF2 explanation will be used for the LF12 terminal node explanation. For LF5, since it is a first-order latent feature with a “remarkable” explanation, so the associated explanation will be used for the LF5 terminal node explanation. In some embodiments, the approach may rank the explanations associated with terminal latent features according to the absolute value of the magnitude of the terminal node pre-activations. For example, referring back to FIG. 9, the LF5 pre-activation (0.9) exceeds the LF12 pre-activation (0.8). Therefore, the explanations are presented in the order of the explanation of LF5 followed by the explanation of LF2, which is a “remarkable” replacement for LF12.

### Use Case 1

In the education industry, accurately predicting a student's potential for success after graduation is invaluable for educational institutions aiming to improve their curricula and support services. A multi-layer neural network model has been developed to forecast a student's post-graduation success, which is defined by a composite score that considers various factors such as employment rate, salary scale, and further education. The model processes a range of input features, including academic performance, extracurricular involvement, internship experiences, and socio-economic background. As each student's data is fed into the model, it predicts their success score. To generate explanations for this predicted score, the system first accesses the neural network model, which includes an input layer with student features, hidden layers with latent features representing complex relationships, and an output layer that predicts the success score. When a student is about to graduate, the model generates a predicted success score based on the current input data. The system then moves to focus on the latent features that provide a more nuanced understanding of the prediction by disregarding the raw input features, such as GPA and number of internships. Subsequently, latent features that are in a non-activation state are removed from consideration, as these features did not contribute meaningfully to the prediction and are thus deemed “unremarkable” for the explanation. The system then selects explanations for the remaining latent features based on their activation states. For instance, a latent feature representing “leadership experience” might be in an active state, suggesting it has a strong influence on the success score. The system combines the explanations of the remaining latent features to construct a comprehensive explanation for the success score, highlighting the impact of leadership roles, research projects, or community service on the student's predicted success. Finally, the system ranks the explanations based on the pre-activation terms of the terminal latent features and presents the explanations in order of their influence on the success score. This ensures that the strongest contributing factors are communicated first. For example, consider a student with a high predicted success score. After the model removes non-contributing features and latent features, it identifies strong internships and leadership roles as the top contributing factors. The explanation provided to the educational institution might state that the student's extensive internship experience in relevant fields, combined with a demonstrated history of leadership in student organizations, are the primary drivers of the high predicted success score. These factors suggest a strong likelihood of post-graduation success in terms of employment opportunities and career advancement. This use case illustrates how the neural network model, coupled with a systematic explanation-generating process, can provide valuable insights into the factors contributing to a student's predicted post-graduation success. Educational institutions can use these explanations to more effectively guide students and enhance their programs to support the success of future graduates.

### Use Case 2

A healthcare analytics company develops a predictive model to assess patient health risks using a neural network with an input layer configured to process comprehensive patient data, including demographics, medical history, genetic information, and lifestyle factors. The model features sparsely connected hidden layers with latent features each associated with an activation-state matrix and associated explanations, allowing for the extraction of complex, non-linear relationships within the data while maintaining explainability. Activation states of these latent features are determined using pre-activation values and an activation function, with each state corresponding to a specific explanation within the matrix. The output layer generates predictions and explanations based on the ranked influence of terminal latent features or preceding latent features that feeding into the terminal latent features, providing clear rationales for the model's activations. When integrated into a hospital's electronic health record system, the model not just predicts patient-specific health risks, such as diabetes or heart disease, but also elucidates the contributing factors-like high BMI or elevated cholesterol levels and combinations of effects-ranked by their impact, thereby enabling healthcare providers to offer personalized interventions and communicate effectively with patients about their health management strategies. For example, a health risk score of 94 out of 100 may come with an explanation that the high score is primarily due to the patient's elevated BMI and a genetic predisposition to diabetes, as indicated by the activation of specific latent features related to metabolic syndrome and family medical history. This is because the input features such as ‘BMI’ and ‘FamilyDiabetesHistory’ have strong connections and activate a critical latent feature that drives the high score, which were activated in a state that the explanation matrix identifies as high risk, and the corresponding weights of these connections contribute to the high pre-activation values, thus influencing the final risk score prominently. This illustrates the importance of the latent feature explanations, as another patient can have a score of 94 but an entirely different relationship that is relevant to explaining their health situation.

### Use Case 3

A bank is facing challenges with fraudulent transactions and seeks to implement a neural network-based fraud detection system that can analyze banking transactions in real-time, identify potential fraud, and provide clear explanations for the flagged transactions to support further investigations and regulatory compliance. The bank integrates the multi-layer model into its transaction processing system. The input layer captures a comprehensive set of transaction features, such as transaction amount, transaction type (e.g., wire transfer, ATM withdrawal), time of transaction, location of transaction, frequency of transactions on the account, account balance before and after the transaction, merchant category (for debit/credit card transactions), and the customer's historical transaction patterns. The hidden layers consist of latent features that are sparsely connected, each associated with a latent feature state activation matrix containing pre-defined explanations for various activation states, corresponding to normal and suspicious transaction patterns. For example, a customer's account shows a sudden high-value transaction at an overseas merchant where the customer has no history of shopping. The input features may include features related to transaction amount, location, and historical patterns that activate specific latent features in the hidden layers and preceding hidden layers, etc. The output layer generates a fraud risk score based on the activation states of the terminal latent features. For this transaction, the score is high, indicating a high risk of fraud. The model ranks the pre-activation terms associated with the preceding and terminal latent features and identifies those that exceed a threshold. The model generates an explanation for the high fraud risk score by combining explanations from the associated preceding and terminal latent features based on the most remarkable and impactful drivers of the output score. In some cases, the model generates an explanation for the high fraud risk score by first removing input features and latent features that are in an off state from consideration. It then traverses the model graph to identify the remaining terminal latent features that are the strongest drivers of the score. The explanation is generated by combining the explanations associated with these remaining latent features, stating: “The transaction was flagged due to an unusually high amount that deviates from the customer's typical transaction range, occurring in a foreign location where no prior activity has been recorded. Additionally, the transaction frequency pattern shows an anomaly compared to the established behavior on the account.” This explanation may be provided to a fraud analyst who may further investigate the transaction. By utilizing the explainable multi-layer model, the bank enhances its fraud detection capabilities with a system that may detect and also explain correctly and deterministically suspicious transactions based on the relationships that drove the output score that has flagged the account.

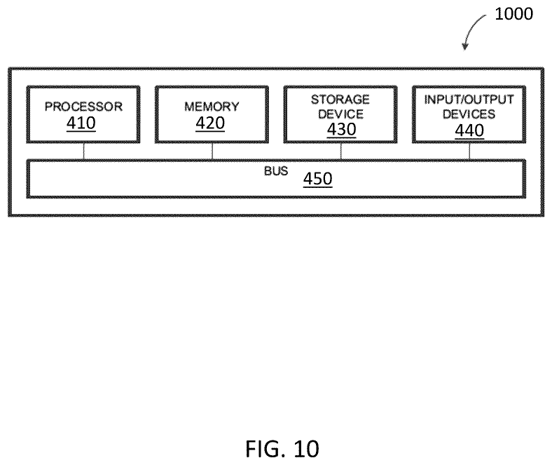

FIG. 10 depicts a block diagram illustrating a computing system 1000 consistent with implementations of the current subject matter. As shown in FIG. 10, the computing system 1000 can include a processor 410, a memory 420, a storage device 430, and input/output devices 440. The processor 410, the memory 420, the storage device 430, and the input/output devices 440 can be interconnected via a system bus 450. The computing system 1000 may additionally or alternatively include a graphic processing unit (GPU), such as for image processing, and/or an associated memory for the GPU. The GPU and/or the associated memory for the GPU may be interconnected via the system bus 450 with the processor 410, the memory 420, the storage device 430, and the input/output devices 440. The memory associated with the GPU may store one or more images described herein, and the GPU may process one or more of the images described herein. The GPU may be coupled to and/or form a part of the processor 410. The processor 410 is capable of processing instructions for execution within the computing system 1000. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 1000. The memory 420 can store data structures representing configuration object databases, for example. The storage device 430 is capable of providing persistent storage for the computing system 1000. The storage device 430 can be a floppy disk device, a hard disk device, an optical disk device, or a tape device, or other suitable persistent storage means. The input/output device 440 provides input/output operations for the computing system 1000. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 1000 can be used to execute various interactive computer software applications that can be used for organization, analysis and/or storage of data in various (e.g., tabular) format (e.g., Microsoft Excel®, and/or any other type of software). Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 1000 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for generating explanations for a multi-layer model, comprising:
accessing a multi-layer model, wherein the multi-layer model comprises an input layer, one or more hidden layers, and an output layer, wherein the input layer comprises a plurality of input features for the multi-layer model, each hidden layer of the one of more hidden layers comprises a plurality of latent features, wherein each latent feature is connected to the input layer or a preceding hidden layer by a limited number of input connections, wherein each latent feature is associated with an activation state matrix, wherein an explanation of a latent feature is selected based on an activation state of said latent feature, and the output layer is capable of generating an output based at least in part on activation states of terminal latent features in a final hidden layer, wherein the terminal latent features are a subset of the latent features that are connected directly to the output layer, and the final hidden layer comprises the terminal latent features;
upon receiving an output generated by the multi-layer model, generating an output explanation by:
removing the input features;
removing the latent features that are in non-activation state;
selecting an explanation of each of the remaining latent features based at least in part on a number of input connections after the removals; and
combining the explanations associated with the remaining latent features to generate the output explanation.

2. The method of claim 1, wherein generating the output explanation further comprises:
ranking pre-activation terms associated with the remaining terminal latent features, respectively; and
generating the output explanation by combining the explanations associated with the remaining terminal latent features in an order of the ranking.

3. The method of claim 1, wherein the explanation of the latent feature is selected by:
retrieving pre-activation terms for each input connections connected to the latent feature by multiplying a value of each input connection by a corresponding weight of the input connection;
transforming the pre-activation terms by an activation function to determine an activation mode for each input connection, wherein the activation modes include negative activation, non-activation, and positive activation;
identifying an activation state for the latent feature by combining the activation modes of the input connections of the latent feature, wherein the activation state corresponds to a cell in the activation state matrix; and
selecting an explanation that corresponds to the identified activation state for the latent feature.

4. The method of claim 3, wherein selecting an explanation that corresponds to the identified activation state for the latent feature further comprises resolving bimodal states by comparing magnitudes of the transformed pre-activation terms of the input connections to determine which input connection has a stronger influence on the latent feature.

5. The method of claim 1, wherein generating the output explanation further comprises:
ranking pre-activation terms associated with the terminal latent features, respectively;
identifying the terminal latent features with the pre-activation term that exceeds a threshold, and
generating the output explanation by combining the explanations associated with the identified terminal latent features in an order of the ranking.

6. The method of claim 1, wherein the limited number is restricted to either one or two input connections per latent feature.

7. The method of claim 6, wherein selecting an explanation of each of the remaining latent features based at least in part on a number of input connections after the removals further comprises:
selecting an explanation for a remaining latent feature based on an activation state of said remaining latent feature if the number of input connections is zero after the removals; and
selecting an explanation for remaining latent feature based on an activation state of an input connection if the number of input connections is one after the removals.

8. A computer program product comprising a non-transient machine-readable medium storing instructions that, when executed by at least one programmable processor, cause the at least one programmable processor to perform operations comprising:
accessing a multi-layer model, wherein the multi-layer model comprises an input layer, one or more hidden layers, and an output layer, wherein the input layer comprises a plurality of input features for the multi-layer model, each hidden layer of the one of more hidden layers comprises a plurality of latent features, wherein each latent feature is connected to the input layer or a preceding hidden layer by a limited number of input connections, wherein each latent feature is associated with an activation state matrix, wherein an explanation of a latent feature is selected based on an activation state of said latent feature, and the output layer is capable of generating an output based at least in part on activation states of terminal latent features in a final hidden layer, wherein the terminal latent features are a subset of the latent features that are connected directly to the output layer, and the final hidden layer comprises the terminal latent features;
upon receiving an output generated by the multi-layer model, generating an output explanation by:
removing the input features;
removing the latent features that are in non-activation state;
selecting an explanation of each of the remaining latent features based at least in part on a number of input connections after the removals; and
combining the explanations associated with the remaining latent features to generate the output explanation.

9. The computer program product of claim 8, wherein generating the output explanation further comprises:
ranking pre-activation terms associated with the remaining terminal latent features, respectively; and
generating the output explanation by combining the explanations associated with the remaining terminal latent features in an order of the ranking.

10. The computer program product of claim 8, wherein the explanation of the latent feature is selected by:
retrieving pre-activation terms for each input connections connected to the latent feature by multiplying a value of each input connection by a corresponding weight of the input connection;
transforming the pre-activation terms by an activation function to determine an activation mode for each input connection, wherein the activation modes include negative activation, non-activation, and positive activation;
identifying an activation state for the latent feature by combining the activation modes of the input connections of the latent feature, wherein the activation state corresponds to a cell in the activation state matrix; and
selecting an explanation that corresponds to the identified activation state for the latent feature.

11. The computer program product of claim 10, wherein selecting an explanation that corresponds to the identified activation state for the latent feature further comprises resolving bimodal states by comparing magnitudes of the transformed pre-activation terms of the input connections to determine which input connection has a stronger influence on the latent feature.

12. The computer program product of claim 8, wherein generating the output explanation further comprises:
ranking pre-activation terms associated with the terminal latent features, respectively;
identifying the terminal latent features with the pre-activation term that exceeds a threshold, and
generating the output explanation by combining the explanations associated with the identified terminal latent features in an order of the ranking.

13. The computer program product of claim 8, wherein the limited number is restricted to either one or two input connections per latent feature.

14. The computer program product of claim 13, wherein selecting an explanation of each of the remaining latent features based at least in part on a number of input connections after the removals further comprises:
selecting an explanation for a remaining latent feature based on an activation state of said remaining latent feature if the number of input connections is zero after the removals; and
selecting an explanation for remaining latent feature based on an activation state of an input connection if the number of input connections is one after the removals.

15. A system comprising:
a programmable processor; and
a non-transient machine-readable medium storing instructions that, when executed by the processor, cause the at least one programmable processor to perform operations comprising:
accessing a multi-layer model, wherein the multi-layer model comprises an input layer, one or more hidden layers, and an output layer, wherein the input layer comprises a plurality of input features for the multi-layer model, each hidden layer of the one of more hidden layers comprises a plurality of latent features, wherein each latent feature is connected to the input layer or a preceding hidden layer by a limited number of input connections, wherein each latent feature is associated with an activation state matrix, wherein an explanation of a latent feature is selected based on an activation state of said latent feature, and the output layer is capable of generating an output based at least in part on activation states of terminal latent features in a final hidden layer, wherein the terminal latent features are a subset of the latent features that are connected directly to the output layer, and the final hidden layer comprises the terminal latent features;
upon receiving an output generated by the multi-layer model, generating an output explanation by:
removing the input features;
removing the latent features that are in non-activation state;
selecting an explanation of each of the remaining latent features based at least in part on a number of input connections after the removals; and
combining the explanations associated with the remaining latent features to generate the output explanation.

16. The system of claim 15, wherein generating the output explanation further comprises:
ranking pre-activation terms associated with the remaining terminal latent features, respectively; and
generating the output explanation by combining the explanations associated with the remaining terminal latent features in an order of the ranking.

17. The system of claim 15, wherein the explanation of the latent feature is selected by:
retrieving pre-activation terms for each input connections connected to the latent feature by multiplying a value of each input connection by a corresponding weight of the input connection;
transforming the pre-activation terms by an activation function to determine an activation mode for each input connection, wherein the activation modes include negative activation, non-activation, and positive activation;
identifying an activation state for the latent feature by combining the activation modes of the input connections of the latent feature, wherein the activation state corresponds to a cell in the activation state matrix; and
selecting an explanation that corresponds to the identified activation state for the latent feature.

18. The system of claim 17, wherein selecting an explanation that corresponds to the identified activation state for the latent feature further comprises resolving bimodal states by comparing magnitudes of the transformed pre-activation terms of the input connections to determine which input connection has a stronger influence on the latent feature.

19. The system of claim 15, wherein generating output explanation further comprises:
ranking pre-activation terms associated with the terminal latent features, respectively;
identifying the terminal latent features with the pre-activation term that exceeds a threshold, and
generating the output explanation by combining the explanations associated with the identified terminal latent features in an order of the ranking.

20. The system of claim 15, wherein the limited number is restricted to either one or two input connections per latent feature.
